(19) United States
(12) Patent Application Publication
(10) Pub. No.: US 2026/0061745 A1
(43) Pub. Date: Mar. 5, 2026

(54) LIQUID EJECTION HEAD BOARD, LIQUID EJECTION HEAD, AND PRINTING APPARATUS

(71) Applicant: CANON KABUSHIKI KAISHA, Tokyo (JP)

(72) Inventor: YOHEI OSUKI, Chiba (JP)

(21) Appl. No.: 19/303,636

(22) Filed: Aug. 19, 2025

(30) Foreign Application Priority Data
Sep. 3, 2024 (JP) 2024-151670

(51) Int. Cl. B41J 2/14

(52) U.S. Cl. CPC B41J 2/14072; B41J 2/1408; B41J 2/14088

(57) ABSTRACT

A liquid ejection head print element board, includes: a heater layer where a plurality of heaters are formed; a wiring layer where common wirings electrically connected to the plurality of heaters are formed; and an anticavitation layer laminated in a first direction on the heater layer, the liquid ejection head print element board further including: a first common wiring that is one of the common wirings and is for supplying voltage from an outside; and a first plug that extends in an opposite direction of the first direction from the heater layer, fills an inside of a through hole directly connected to the heater with a conductive material, and supplies voltage to the heater, in which the first common wiring and the first plug are electrically connected to each other via wiring formed of a material identical to that of the anticavitation layer.

### BACKGROUND

### Field of the Technology

The present disclosure relates to a liquid ejection head board, a liquid ejection head, and a printing apparatus for ejecting ink according to a liquid ejecting method, and printing on a print medium.

### Description of the Related Art

Inkjet print heads (hereinafter, print heads) that form ink droplets to be ejected according to various systems have been known. Among them, a print head that uses a system of using heat from heaters to eject ink can relatively easily implement multiple nozzles with a high density, and can print at high resolution with high image quality.

It has been known that in the case where the plurality of heaters are simultaneously driven for printing, the voltage drop due to wiring is different depending on the number of simultaneously driven heaters, the energy supplied to the heaters vary depending on the simultaneously driven number, and the ejection stability decreases. To solve this, the inkjet print head uses a common wiring that has a thicker wiring layer connected to the heaters, and a width as large as possible in order to reduce the electrical resistance of the wiring that causes voltage drop.

In the inkjet print head, overcurrent flows through the heater element due to occurrence of abnormal pulses such as noise, and an unexpected wire break at the heater element of the print element board occurs in some cases. Since the heater element and therearound are exposed to ink, the wiring connected to the heater is exposed to the ink in case of a wire break at the heater element. On the other hand, the common wiring is supplied with voltage to drive another normal heater element, and dissolution of the wiring originated from the heater element with a wire break occurs. If this state continues, the dissolution of the wiring propagates to the wiring of the adjacent heater element, and the heater elements get into collective malfunction originated from the heater element with the wire break. In recent years, a technology that detects a heater element with a wire break, and causes another normal heater element to complementally act for the heater element with the wire break has been introduced. However, if the heater elements get into collective malfunction, it is difficult to cause another normal heater element to complementally act for them, resulting in reduction in image quality.

To prevent such propagation of the wire break due to wiring dissolution, an inkjet print head described in Japanese Patent Laid-Open No. 2020-179527 (hereinafter, called Literature 1) has, as a proposal in the document, a configuration through a through hole in which barrier metal is sufficiently covered and which has a low aspect ratio (through hole height/through hole diameter). According to this configuration, the individual wiring connected to the heater element passes through the through hole with the barrier metal layer with favorable coverability before connection to the power source wiring. Accordingly, even in case a wire break occurs and tungsten dissolves due to ink, the progress of dissolution can be prevented by the barrier metal layer.

As the densification of the semiconductor technology advances, the through hole diameter is miniaturized along with the miniaturization of the wiring. Preferably, the film thickness of the wiring is high to reduce the wire resistance in order to reduce the voltage drop. However, as the thickness of the wiring layer increases, the film thickness of the insulating film between layers increases and the height of the through hole also increases accordingly. These backgrounds indicate that the aspect ratio of the through hole tends to increase, and the coverability of the barrier metal layer at the plug bottom section tends to be degraded. Literature 1 discloses the configuration of preventing the wiring from dissolving by the barrier metal layer of the plug portion.

### SUMMARY

To solve the problem described above, a liquid ejection head print element board according to an aspect in the present disclosure, includes: a heater layer where a plurality of heaters are formed; a wiring layer where common wirings electrically connected to the plurality of heaters are formed; and an anticavitation layer laminated in a first direction on the heater layer, the liquid ejection head print element board further including: a first common wiring that is one of the common wirings and is for supplying voltage from an outside; and a first plug that extends in an opposite direction of the first direction from the heater layer, fills an inside of a through hole directly connected to the heater with a conductive material, and supplies voltage to the heater, in which the first common wiring and the first plug are electrically connected to each other via wiring formed of a material identical to that of the anticavitation layer.

Features of the present disclosure will become apparent from the following description of embodiments with reference to the attached drawings. The following description of embodiments is described by way of example.

### BRIEF DESCRIPTION OF THE DRAWINGS

FIG. 1 is a perspective view showing an overview of a configuration of a printing apparatus that includes a print head as a typical exemplary embodiment in the present disclosure;

FIG. 2 is a block diagram showing a control configuration of the printing apparatus shown in FIG. 1;

FIG. 3 shows a layout configuration of an element board (head board) implemented in the print head;

FIG. 4 is an enlarged view of an X part of the element board shown in FIG. 3;

FIG. 5 shows an equivalent circuit of a drive circuit that drives one heater;

FIG. 6 is a sectional view showing a multilayer structure of an element board according to a first embodiment;

FIG. 7 is a partial top view of an element board in a case where each anticavitation wiring 361 is an individual wiring;

FIG. 8 is a partial top view of an element board in a case where the anticavitation wiring 361 is a common wiring;

FIG. 9 is a sectional view showing a multilayer structure of an element board according to a second embodiment;

FIG. 10A shows the coverability of a barrier metal layer in a case where the aspect ratio of a through hole is high;

FIG. 10B shows the coverability of a barrier metal layer in a case where the aspect ratio of the through hole is low;

FIG. 11 is a sectional view schematically showing the dissolution progress in the case where the aspect ratio of the through hole is high;

FIG. 12A is a top view schematically showing the initial dissolution progress of the element board in the case where the aspect ratio of the through hole is high;

FIG. 12B is a top view schematically showing the element board where dissolution has progressed in the case where the aspect ratio of the through hole is high;

FIG. 13 shows a sectional view showing a multilayer structure of a conventional element board; and

FIG. 14 schematically shows a situation where a plug has dissolved due to a wire break at the wiring of the element board in the first embodiment.

### DESCRIPTION OF THE EMBODIMENTS

Referring to the accompanying drawings, preferred exemplary embodiments in the present disclosure are further specifically described in detail below. Note that the following embodiments do not limit the invention according to the claims. With the embodiments, a plurality of characteristics are described. However, not all of these characteristics are necessary for the invention. The characteristics may be freely combined. Furthermore, in the accompanying drawings, identical or similar components are assigned the same reference numerals, and redundant description is omitted.

Note that in this specification, “printing” (sometimes called “print”) is not limited to a case of forming characters, diagrams, and other meaningful information, and encompasses meaningful and meaningless cases. Irrespective of whether what is elicited to be visually perceived by humans, it also widely represents cases of forming images, designs, patterns and the like on a print medium, or processing a medium.

The “print medium” represents not only paper used for a typical printing apparatus but also cloth, plastic, films, metal plates, glass, ceramics, wood, leather, and other media capable of accepting ink in a broader sense.

Furthermore, “ink” (sometimes called “liquid”) should be broadly construed in a manner similar to the definition of the “printing (print)” described above. Consequently, it represents liquid that can be provided for formation of images, designs, patterns and the like or processing the print medium, or ink processing (e.g., solidification or insolubilization of colorants in the ink to be supplied onto the print medium), by being supplied onto the print medium.

Furthermore, “nozzle” collectively represents an ejection port and a liquid path that communicates therewith, and an element that generates energy used for ink ejection, unless otherwise specified.

The element board (head board) for the print head used below does not indicate a simple base substrate made of silicon semiconductor, but indicates a configuration provided with elements, wiring and the like instead.

Furthermore, “on the board” indicates not only “on the element board” but also the surface of the element board and an inner side of the element board adjacent to the surface. “Build-in” in the present disclosure is not a term that does not indicate arrangement of separate elements simply on the surface of the base substrate as separate objects, but indicates integral formation and fabrication of elements on an element substrate by a semiconductor circuit manufacturing process and the like.

### Description of Overview of Printing Apparatus

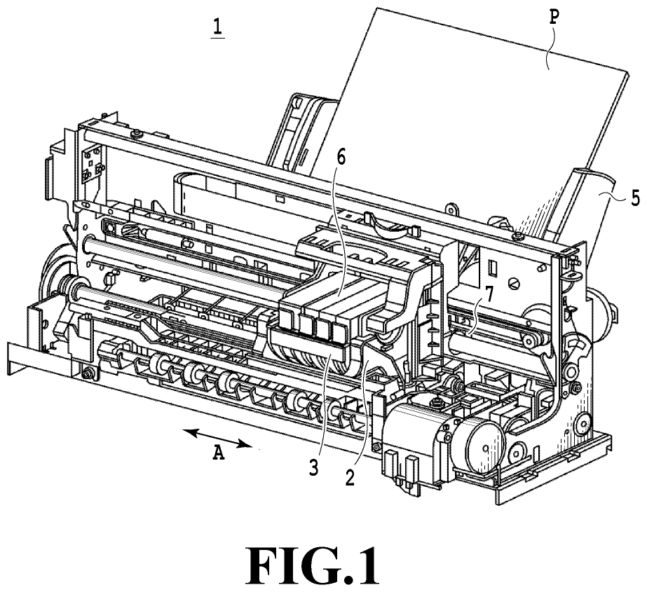

FIG. 1 is an outer appearance perspective view showing an overview of a configuration of a printing apparatus that prints using an inkjet print head (hereinafter, the print head) that is a typical exemplary embodiment in the present disclosure.

As shown in FIG. 1, an inkjet printing apparatus (hereinafter, the printing apparatus) 1 includes an inkjet print head (hereinafter, the print head) 3 that ejects ink according to the inkjet system and prints, and is mounted on a carriage 2. The carriage 2 is then reciprocally moved in an arrow A direction and prints. A print medium P, such as print paper, is fed through a sheet feeding mechanism 5, and is conveyed to a printing position, and ink is ejected from the print head 3 to the print medium P at the printing position, thus perform printing.

The print head 3 is mounted on the carriage 2 of the printing apparatus 1, and an ink tank 6 that stores ink to be supplied to the print head 3 is further mounted on the print head 3. The ink tank 6 is detachably attached to the carriage 2.

The printing apparatus 1 shown in FIG. 1 can perform color printing, and four ink cartridges that respectively contain magenta (M), cyan (C), yellow (Y), and black (K) inks are mounted on the carriage 2. These four ink cartridges can be independently detached and attached.

The print head 3 in this exemplary embodiment adopts an inkjet system that ejects ink using thermal energy. To achieve this, elctrothermal transducer elements (heaters) are provided. The elctrothermal transducer elements are respectively provided for the ejection ports, and eject the inks through the corresponding ejection ports by applying pulse voltage to the corresponding elctrothermal transducer elements according to a print signal. Note that the printing apparatus 1 is not limited to the serial-type printing apparatus described above, and may be applied to a full-line type printing apparatus where print heads (line heads) provided with ejection ports arranged in the width direction of a print medium are arranged in the conveyance direction of the print medium.

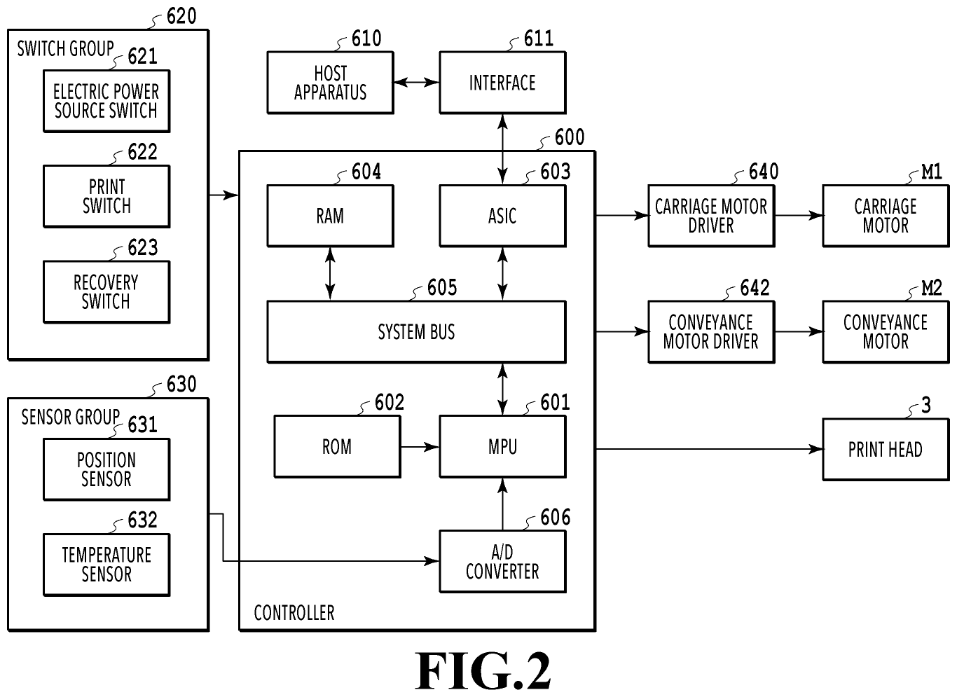

FIG. 2 is a block diagram showing a control configuration of the printing apparatus shown in FIG. 1. As shown in FIG. 2, a controller 600 includes an MPU 601, a ROM 602, an application specific integrated circuit (ASIC) 603, a RAM 604, a system bus 605, an A/D converter 606 and the like. Here, the ROM 602 stores programs, required tables, other fixed data that support a control sequence described later. The ASIC 603 generates the control signal for control of a carriage motor M1, control of a conveyance motor M2, and control of the print head 3. The RAM 604 is used as a rasterization region for image data, a work area for executing the programs, and the like. The system bus 605 connects the MPU 601, the ASIC 603, and the RAM 604 to each other, and transmits and receives data. The A/D converter 606 receives an analog signal from an after-mentioned sensor group, performs A/D conversion, and supplies a digital signal to the MPU 601.

In FIGS. 2, 610 denotes a host apparatus that corresponds to a host or an MFP serving as a supply source of image data. Image data, commands, statuses and the like are transmitted and received between the host apparatus 610 and the printing apparatus 1 via an interface (I/F) 611 through packet communication. Note that besides a network interface, a USB interface may be provided as the interface 611, thus allowing bit data and raster data serially transferred from the host to be received.

Furthermore, 620 denotes a switch group, which includes an electric power source switch 621, a print switch 622, a recovery switch 623 and the like.

630 denotes a sensor group for detecting the states of the apparatus, and includes a position sensor 631, a temperature sensor 632 and the like. In this exemplary embodiment, photo sensors that detect the ink remaining amounts are provided besides them.

Furthermore, 640 denotes a carriage motor driver that drives the carriage motor M1 for achieving reciprocally scanning with the carriage 2 in the arrow A direction, and 642 denotes a conveyance motor driver that drives the conveyance motor M2 for conveying the print medium P.

During print scan by the print head 3, the ASIC 603 directly accesses the storage region of the RAM 604, and transfers data for driving heating elements (heaters for ejecting ink), to the print head. In addition, the printing apparatus is provided with a display that includes an LCD or an LED, as a user interface.

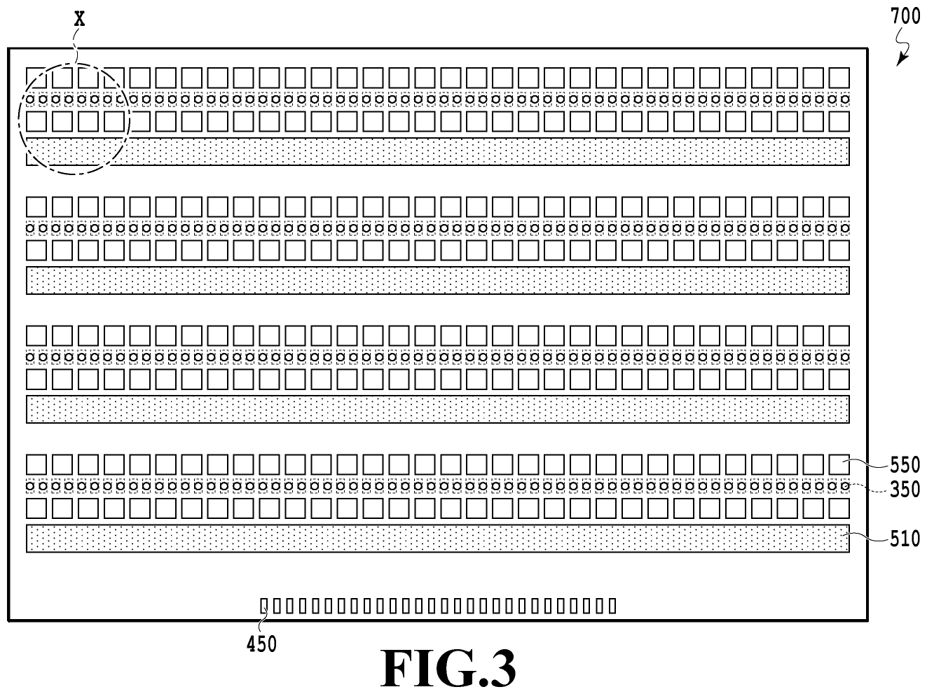

FIG. 3 is a plan view showing the layout configuration of an element board 700 implemented on the print head 3. The plane of the element board 700 shown in FIG. 3 has a rectangular shape. A plurality of pads 450 are provided along a long side of the rectangle plane of the element board 700. Data and a drive voltage are provided from the outside (the main body of the printing apparatus) through these pads. A plurality of heaters 350, a plurality of ink supply ports 550, and a plurality of switching elements 510 are arrayed in the long side direction of the element board 700.

As shown in FIG. 3, four sets of heater arrays (350), ink supply port arrays (550), and rows of switching elements (510) are provided. These sets are respectively used to individually print using magenta (M), cyan (C), yellow (Y), and black (K) inks on a set-by-set basis.

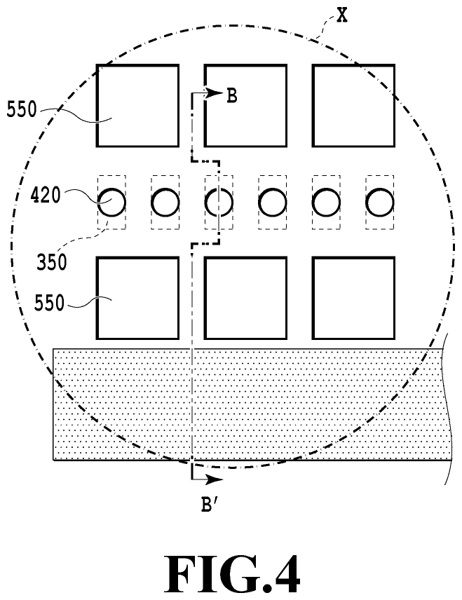

FIG. 4 is an enlarged view of an X part indicated in FIG. 3. As shown in FIG. 4, ejection ports 420 that eject ink droplets are provided in association with the respective heaters 350. The ink supply ports 550 associated with the corresponding heaters are provided on the opposite sides of the ejection port array.

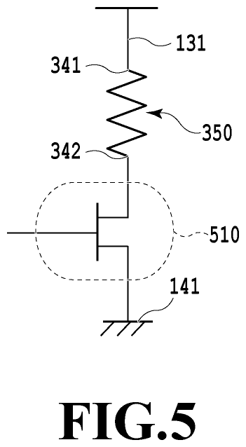

FIG. 5 shows an equivalent circuit of a drive circuit that drives one heater. As shown in FIG. 5, a junction 341 on one side of the heater (heat generating resistor) 350 is electrically connected to a VH common wiring 131 for supplying voltage. Furthermore, another junction 342 of the heater 350 is electrically connected to a GND common wiring 141 via a switching element 510 (driver) for turning on and off driving of the heater 350. In this exemplary embodiment, the switching element 510 is a MOSFET. The drive voltage from the outside is applied to the gate of the MOSFET, switches the on and off, and drives the heater 350.

Next, an exemplary embodiment of the element board implemented on the print head of the printing apparatus that has the aforementioned configuration is described. First, the element board having the conventional configuration as a comparative example is herein described, and subsequently, the characteristics of the element board according to the exemplary embodiment are described.

### Description of Print Element Board Manufacturing Method and its Problem

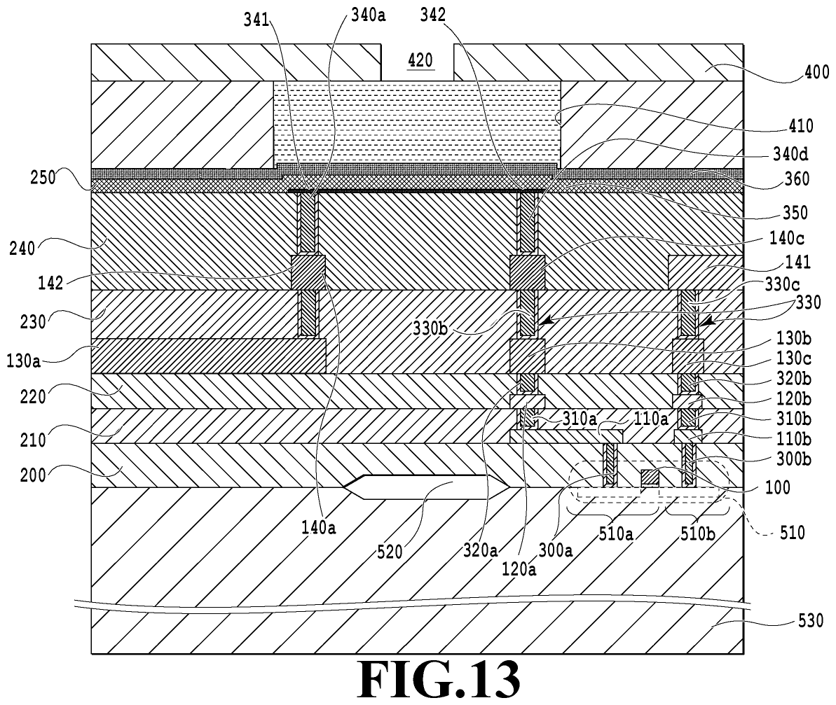

FIG. 13 shows a sectional view showing the multilayer structure of the conventional element board as the comparative example. This sectional view is a sectional view taken along B-B′ shown in FIG. 4. As shown in FIG. 13, on a silicon substrate 530 there are film-formed a Poly-Si layer 100, wiring layers 110, 120, 130, and 140, a heater 350, and an anticavitation layer 360 along a first direction. In FIG. 13, the silicon substrate 530 side is assumed as a lower side of the first direction, and the ejection ports 420 side is assumed as the upper side of the first direction. The wiring layers are insulated by insulation layers 200, 210, 220, 230, 240, and 250. To electrically connect each line of wiring, through holes 300, 310, 320, 330, and 340 that extend in the first direction and penetrate through the insulation layers are formed.

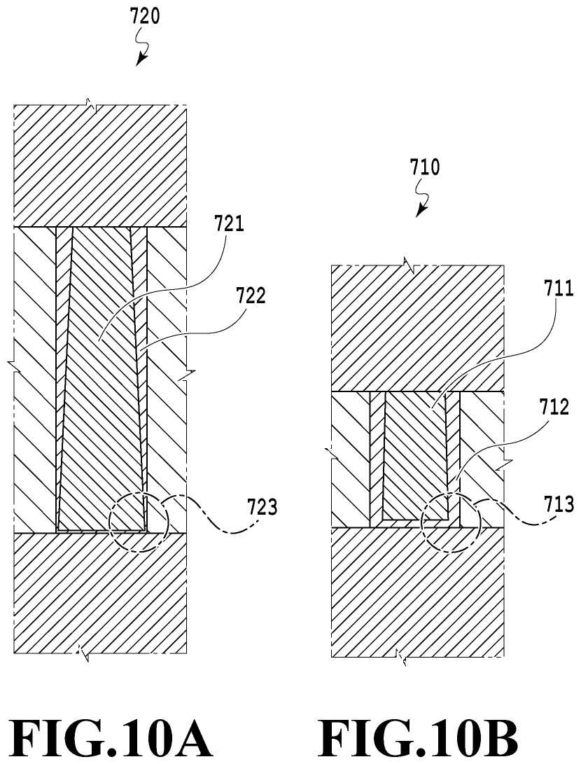

Next, the difference depending on the aspect ratio of the through hole when ink enters the wiring and the through hole in case of a wire break is described. FIGS. 10A and 10B show the coverability of a barrier metal layer depending on the difference of the aspect ratio of the through hole for a plug. Typically, the plugs are formed of tungsten (W) (721 and 711), and the barrier metal layers (722 and 712) are formed of, for example, a material containing titanium Ti (e.g., TiN) and have a thickness ranging from 10 nm to 30 nm. Til is a material that is often used for a semiconductor element board as an anti-diffusion film, and a close contact film, and has a high corrosion resistance. Accordingly, even when ink enters the inside the element board, an aluminum alloy that is the wiring material and tungsten of the plug are dissolved into the ink, and corrosion occurs, the titanium nitride film remains without corrosion.

As described above, the titanium nitride film is formed as the barrier metal layer so as to surround the metal plug. Typically, when the titanium nitride film is formed by sputtering film forming method, the titanium nitride film is not necessarily uniformly formed at the bottom section of the through hole formed by penetrating the insulation layer. Accordingly, a portion where the coverability of the metal plug with the barrier metal layer is insufficient sometimes occurs. In particular, as the aspect ratio (through hole height/through hole diameter) of the through hole is higher, it becomes more difficult to deliver the film formation material to the bottom section of the through hole, and it becomes more difficult to achieve the coverability.

For example, in a case where the through hole height is 0.6 μm and the through hole diameter is 0.4 μm, the aspect ratio is 0.6/0.4=1.5. If the aspect ratio is 1.5, the coverability of the barrier metal is favorable. On the other hand, in a case where the through hole height is 1.4 μm and the through hole diameter is 0.6 μm, the aspect ratio is 1.4/0.6=2.333. If the aspect ratio is greater than 2, it is difficult for the barrier metal layer to achieve a sufficient coverability at a corner portion of the through hole.

On the other hand, in a case of arranging the circuit of the heater elements and the like at high density, the wiring is miniaturized, and the through hole diameter is also miniaturized. Preferably, the film thickness of the wiring is high to reduce the wire resistance in order to reduce the voltage drop. However, as the thickness of the wiring layer increases, the film thickness of the insulating film between layers increases and the height of the through hole also increases accordingly. These backgrounds indicate that the aspect ratio of the through hole tends to increase, and the coverability of the barrier metal layer at a corner portion 723 tends to be degraded. In FIG. 10A, the through hole height is greater than that in FIG. 10B, and toward the bottom section, the barrier metal layer 722 tends to be thinner. According to a typical sputtering film forming method, if the film-forming time period is extended, the barrier metal layer becomes thick at a flat portion, but it is difficult to significantly improve the film thickness in a region on the through hole bottom section side that the film formation material tends not to reach.

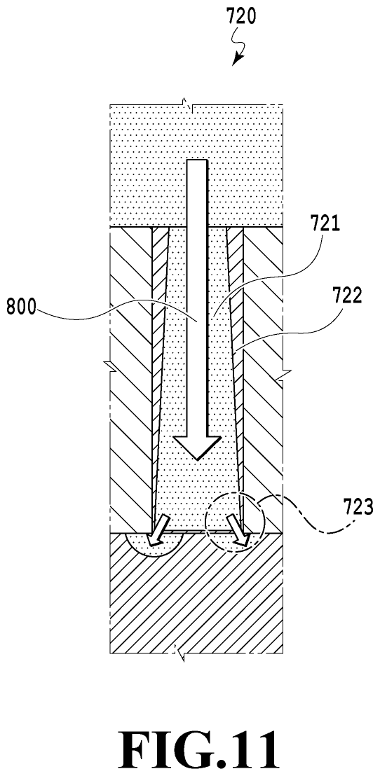

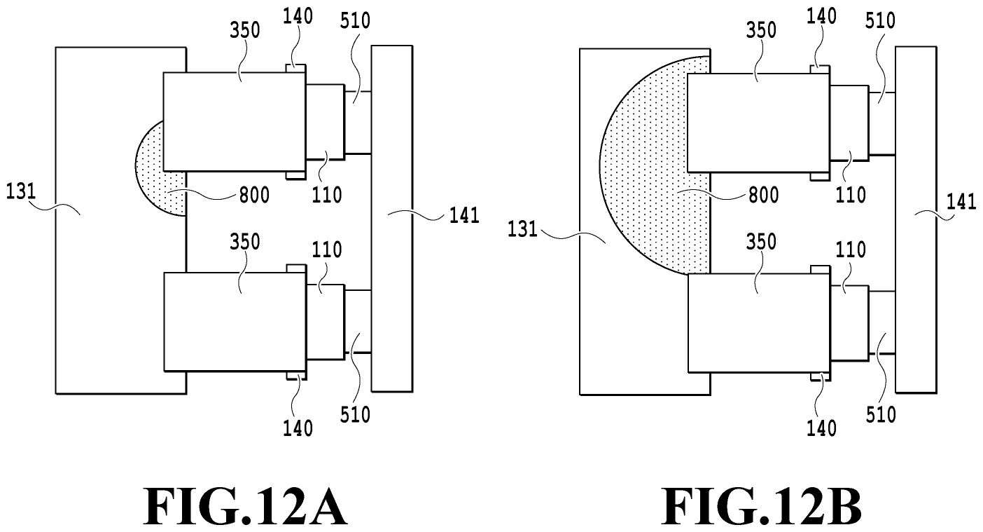

Accordingly, in case of a wire break, as shown in FIG. 11, dissolution progresses from a portion at the through hole bottom corner portion where the coverability of the barrier metal layer is poor. If such dissolution progress reaches the power supply line of the adjacent heater element as shown in FIG. 12B, the adjacent heater element does not function either. Consequently, according to the inventors'discussion, if the aspect ratio is higher, there is a possibility that the barrier metal layer is insufficiently covered, ink enters from the insufficiently covered portion, and the dissolution of the wiring progresses. That is, the configuration in Literature 1 cannot be applied to a manufacturing process for a semiconductor having a through hole that is not subject to sufficient reduction in aspect ratio for prevention of the dissolution due to ink.

Next, an exemplary embodiment of the element board implemented on the print head in the present disclosure is described.

### First Embodiment

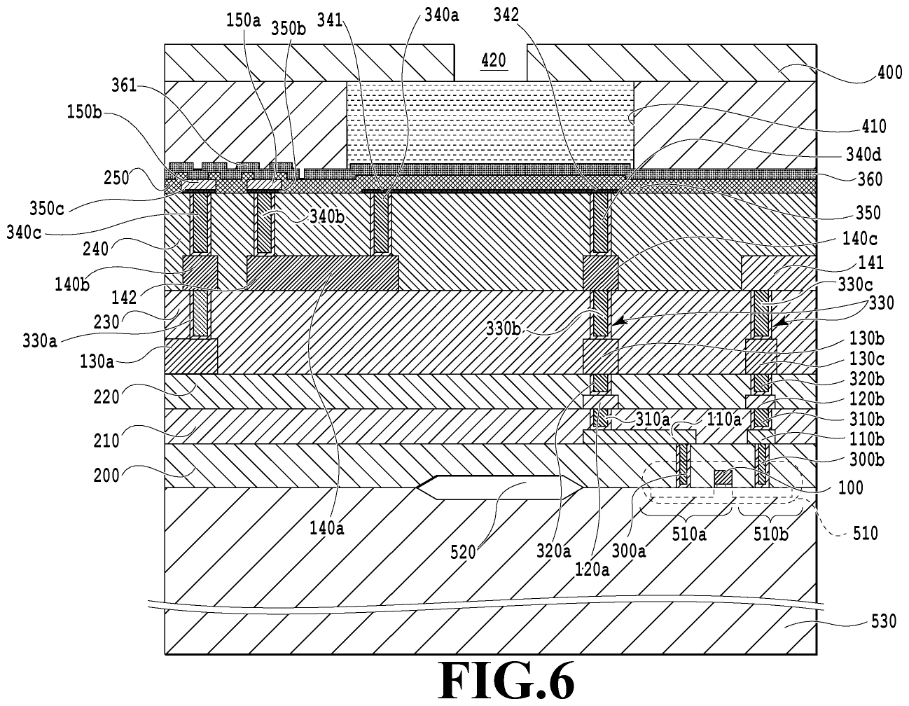

FIG. 6 is a sectional view of a heater element portion in a first embodiment. On a substrate 530 there are film-formed a Poly-Si layer 100, wiring layers 110, 120, 130, and 140, a heater layer 350, a wiring layer 150 formed on the heater layer, and an anticavitation layer 360 along the first direction. The upper and lower senses of the first direction are similar to those in FIG. 13. These lines of wirings are insulated by insulation layers 200, 210, 220, 230, 240, and 250. To electrically connect each line of wiring, through holes 300, 310, 320, 330, and 340 that extend in the first direction and penetrate through the insulation layers are formed.

A junction 341 of the heater element 350 is connected to a wiring layer 140a via a through hole 340a. Furthermore, the wiring layer 140a is connected sequentially through a through hole 340b, a heater layer 350b, and a wiring layer 150a, to a wiring 361 formed of the same material as that of the anticavitation layer 360, and to a wiring layer 150b. Next, the wiring layer 150b is connected sequentially through a heater layer 350c, a through hole 340c, a wiring layer 140b, and a through hole 330a, to a VH common wiring 130a formed of the wiring layer 130. Here, unlike an after-mentioned VH common wiring 130d, the wiring layer 140b is individually provided for each heater element on a separated manner. The VH common wiring 130a is connected to some of the pads 450 of the print element board, and supplied with a voltage from the outside.

The other junction 342 of the heater element is connected through the through hole 340d to the wiring layer 140c, and further connected through a through hole 330b, a wiring layer 130b, and a through hole 320a to a wiring layer 120a. Furthermore, the wiring layer 120a is connected through a through hole 310a to a wiring layer 110a, and through a through hole 300a to one (510a) switching element 510.

The other switching element (510b) is connected sequentially through a through hole 300b, a wiring layer 110b, a through hole 310b, a wiring layer 120b, a through hole 320b, a wiring layer 130c, and a through hole 330c, to the GND common wiring 141. The GND common wiring 141 is formed of the wiring layer 140. An ink chamber 410 is provided above the heater element. When the switching elements 510 is activated according to data from the outside, current flows through the heater element, bubbles are generated in ink due to heat generation of the heater element, and the ink is ejected through the ejection port 420.

Here, it is preferable that in view of energy saving, the heater layer 350 should be formed to have a high resistance. A high resistance value can be achieved by increasing the specific resistance of the material and reducing the film thickness. For example, the heater layer may be formed of TaSiN with a thickness ranging from approximately 10 nm to 50 nm.

The wiring layers 110, 120, 130, and 140 can be made of aluminum or an alloy containing aluminum (AlSi, AlCu or the like). For example, the wiring layers 130 and 140 are used to allow current to flow through the heater. Accordingly, the flowing current tends to be significantly affected by the wire resistance. Accordingly, the film thickness is relatively high, and is higher or equal to 600 nm.

The insulation layers 200, 210, 220, 230, and 240 are required to sufficiently cover the wiring in order to electrically insulate the wiring lines, and have film thicknesses that are different depending on the wiring film thickness on the lower layer. For example, in a case where the wiring layer 130 is formed to have a film thickness of 600 nm, the insulation layer 230 thereabove is typically formed to have a thickness of 600 nm or more. In a case where the wiring layer 130 is formed to have a film thickness of 1,000 nm, the insulation layer 230 thereabove is typically formed to have a thickness of 1,000 nm or more.

On the other hand, the insulation layer 250 may have a reduced film thickness to cover a heater with a thin film thickness. Also in view of energy saving, it is preferable to further reduce the film thickness in order to efficiently transfer heat generated by the heater element to ink. The insulation layer 250 may be formed to have a thickness ranging from approximately 150 nm to 300 nm.

The plug is formed of tungsten, and the barrier metal layer is formed of, for example, a material containing titanium Ti (e.g., TiN) and has a thickness ranging from 10 nm to 30 nm.

Next, the wiring 361 may be formed of, for example, Ta, Ti, TaN, TiN, etc. These materials are materials resistant to dissolution even with application of voltage in a state of contact with ink. In the present exemplary embodiment, the wiring 361 is formed of a material identical to that of the anticavitation layer 360 with a thickness ranging from 200 nm to 300 nm, for example. For example, if the wiring 361 is formed by the same process as that for the anticavitation layer 360 on the heater element, the processing cost can be reduced. Since the anticavitation layer originally has a contact with ink in the configuration, a material with a high ink resistance is used for the anticavitation layer in view of its functionality. The wiring 361 connects, to each other, the wiring layers 150a and 150b formed by respectively providing openings in the insulation layer 250. In this case, the insulation layer 250 is formed to have a thin film thickness as described above. The film thickness of the insulation layer 250 is less than the depth of the through hole 340.

For example, even in a case where the insulation layer opening with a width of 0.4 μm is formed in the insulation layer 250 with a film thickness of 0.2 μm, 0.2/0.4=0.5 holds, and the aspect ratio can thus be reduced. In actuality, the width of the insulation layer opening can be further increased, the aspect ratio can be further reduced. For example, if the wiring 361 is formed to have a thickness of 200 nm in the opening formed in the insulation layer with a thickness of 200 nm, a sufficient film thickness can be secured even at the bottom section of the opening. As a result, the junction between the wiring 361 and the wiring layer 150 can be formed in a state of being sufficiently covered with the anticavitation layer having excellent ink resistance.

As described above, at the part of the wiring that electrically connects the heater element 350 and the VH common wiring 130a to each other is provided with the wiring (anticavitation wiring) 361 formed of the material identical to that of the anticavitation layer 360. The anticavitation wiring 361 can also function as a buffer for preventing each heater portion from being affected due to a wire break. It is conceivable that the junction 341 of the heater element 350 is broken in case of a wire break at the heater portion. However, the buffer portion functions to prevent the VH common wiring 130a from being affected by the wire break at the heater portion.

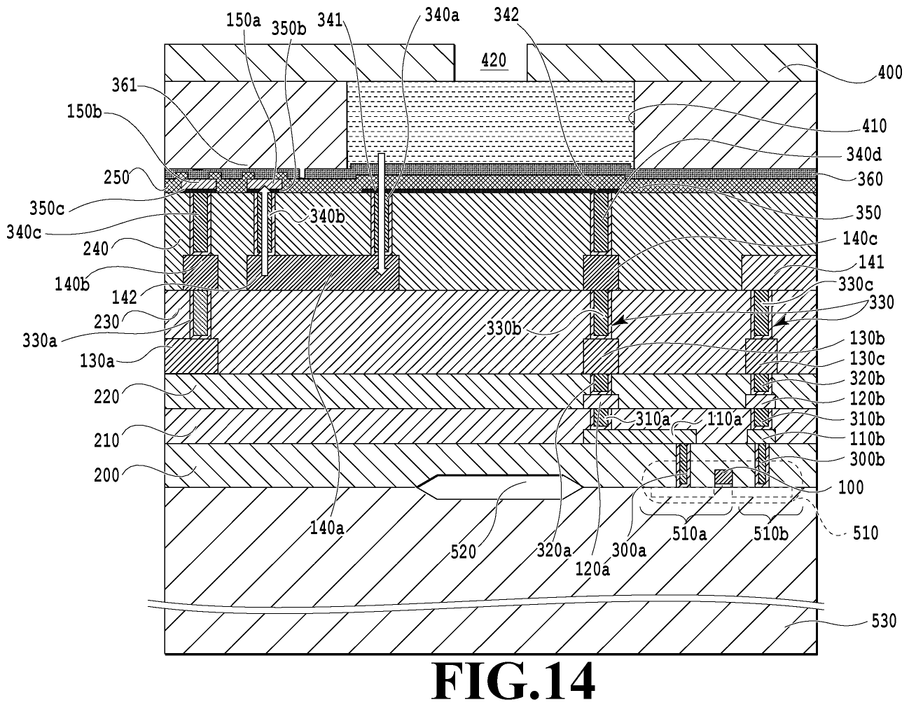

FIG. 14 schematically shows a situation where the plug has dissolved due to a wire break at the wiring of the element board shown in FIG. 6. As shown in FIG. 14, a plug 340a dissolves by the wire break, and the dissolution affects the wiring 140a, the plug 340b, and the wiring layer 150a. However, the progress of the dissolution is stopped in the wiring 361. Accordingly, the dissolution does not reach the VH common wiring 130a, and the dissolution does not progress to the line portion of the adjacent heater.

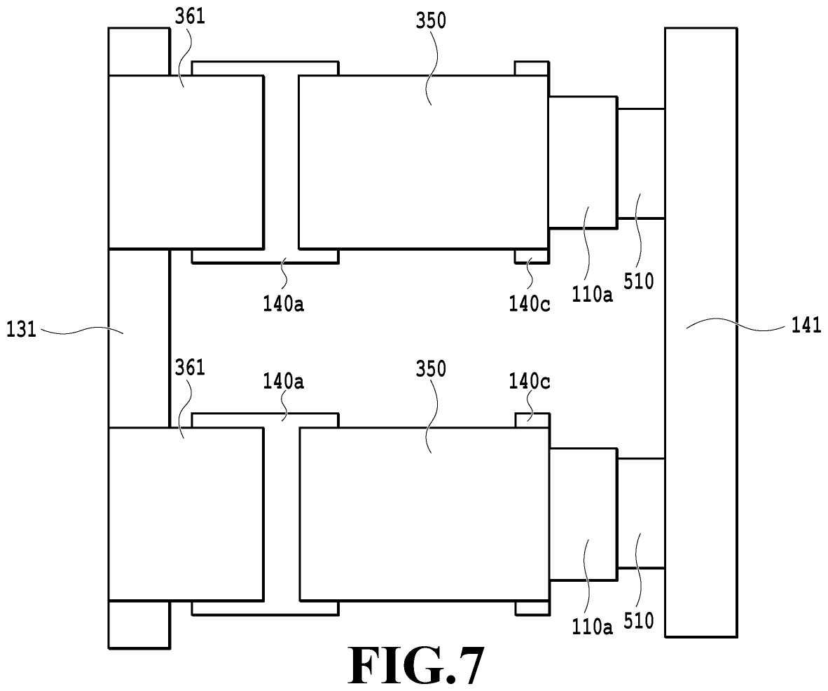

FIG. 7 is a top view showing a situation of wirings of two heaters implemented in the element board shown in FIG. 6 in a case where the anticavitation wiring 361 is discrete wiring. Note that in this diagram, the anticavitation layer 360 on the heater is omitted. As shown in FIG. 7, the anticavitation wiring 361 may be formed for each heater element, and electrically connect a common wiring 131 and the plurality of heater elements to each other.

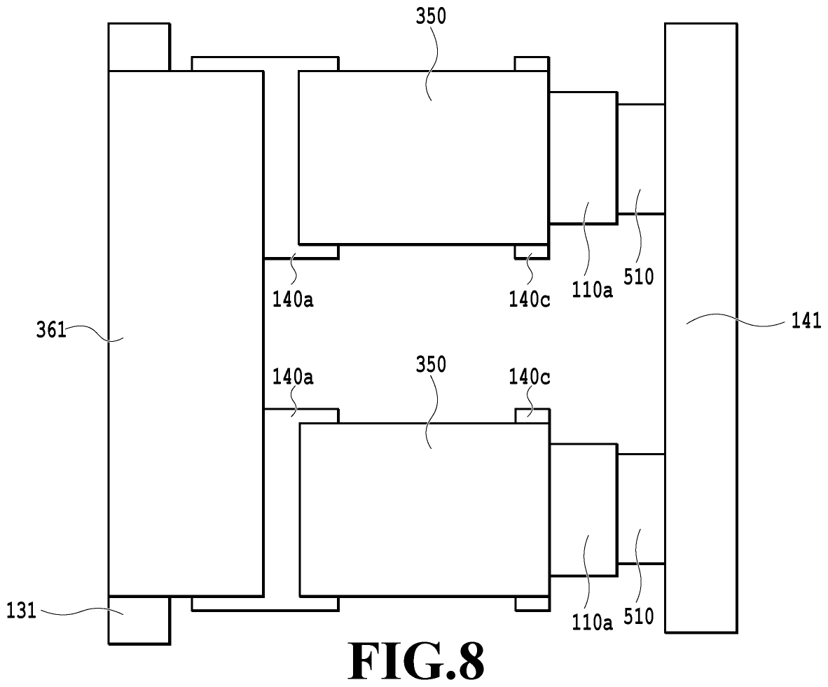

FIG. 8 is a top view showing a situation of a wiring of the two heaters implemented in the element board shown in FIG. 6 in a case where the anticavitation wiring 361 is the common wiring. As shown in FIG. 8, the anticavitation wiring 361 may electrically connect the common wiring 131 and at least two heater elements to each other. Even in this case, the anticavitation wiring 361 can function as a buffer portion in case of a wire break at the heater portion, and prevent the VH common wiring 131 from being affected by the wire break.

Preferably, the anticavitation wiring 361 is thick to reduce the wire resistance. However, an increased film thickness increases the stress of the entire element board. Accordingly, it is preferable to only increase the thickness of the anticavitation wiring 361 portion. For example, only the anticavitation wiring 361 portion may be film-formed twice to increase the thickness. According to another method, while the same material as that of the anticavitation layer may be adopted, the film may be formed by another process. Furthermore, the anticavitation wiring 361 and the anticavitation layer 360 on the heater may be formed by the same process, and only the anticavitation layer on the heater may be etched to be thinned. Note that the anticavitation wiring 361 and the anticavitation layer 360 may be provided on the same wiring layer, or provided on wiring layers different from each other.

The anticavitation layer may be formed of a plurality of layers. For example, it may be formed of a plurality of layers that include a lower layer of Ta, and an upper layer of Ir. Ta functions as a film for preventing dissolution of the wiring, and Ir functions as a film with a higher anticavitation property at the heater portion.

An upper part of the anticavitation wiring 361 may be covered with a nozzle material 400. An insulation layer (not shown) may be formed between the anticavitation wiring 361 and the nozzle material. The insulation layer may be formed of SiO, SiC, SiOC, SiON, SiOCN or the like. The insulation layer is expected to achieve an advantage of improving the adhesiveness between the anticavitation layer 360 and the nozzle material 400. By securing the adhesiveness by the insulation layer, the material of the anticavitation wiring 361 may be formed using a film excellent in resistance to dissolution.

According to the exemplary embodiment described above, even with the high aspect ratio of the through hole, the dissolution in ink can be prevented from progressing by the sufficiently covered anticavitation layer excellent in resistance to dissolution, and propagation to the adjacent heater in case of a wire break can be prevented.

### Second Embodiment

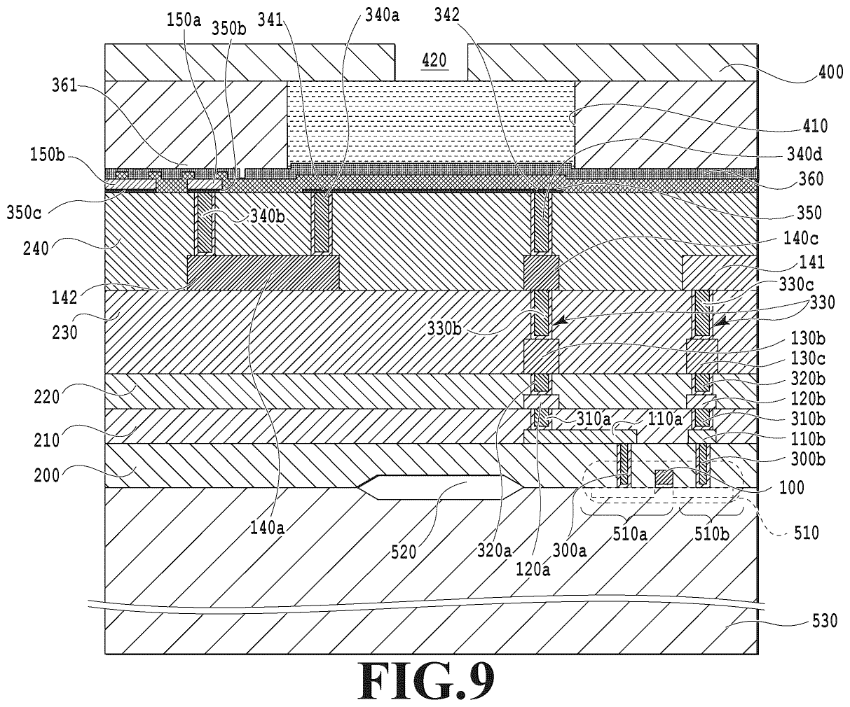

FIG. 9 is a sectional view of a heater element portion in a second embodiment. On a substrate 530 there are film-formed a Poly-Si layer 100, wiring layers 110, 120, 130, and 140, a heater layer 350, a wiring layer 150 formed on the heater layer, and an anticavitation layer 360 along the first direction. The upper and lower senses of the first direction are similar to those in FIG. 13. These lines of wirings are insulated by insulation layers 200, 210, 220, 230, 240, and 250. To electrically connect each line of wiring, through holes 300, 310, 320, 330, and 340 that extend in the first direction and penetrate through the insulation layers are formed. A junction 341 of the heater element 350a is connected to a wiring layer 140a via a through hole 340a. Furthermore, the wiring layer 140a is connected sequentially through a through hole 340b, a heater layer 350b, and a wiring layer 150a formed on the heater layer 350b, to an anticavitation wiring 361, and to a VH common wiring 150b formed of the wiring layer 150. In this case, the wiring layer 150 has a lower resistance value than the heater layer 350. Accordingly, most of the current flows into the wiring layer 150. Accordingly, at a portion on the heater layer where the wiring layer 150 is present, current hardly flows to the heater layer, and heat is hardly generated.

At the junction 342 of the heater element 350, the heater element is connected through the through hole 340d to one switching element (510a) in a manner similar to FIG. 6. Next, similar to FIG. 6, the other switching element (510b) is electrically connected to the GND common wiring 141. The ink chamber 410 is provided above the heater element. When the switching element 510 is activated according to data from the outside, current flows through the heater element, bubbles are generated in ink due to heat generation of the heater element, and the ink is ejected through the ejection port 420.

While the present disclosure has been described with reference to embodiments, it is to be understood that the present disclosure is not limited to the disclosed embodiments. The scope of the following claims is to be accorded the broadest interpretation so as to encompass all such modifications and equivalent structures and functions.

This application claims the benefit of Japanese Patent Application No. 2024-151670, filed Sep. 3, 2024, which is hereby incorporated by reference herein in its entirety.

What is claimed is:

1. A liquid ejection head print element board, comprising:
a heater layer where a plurality of heaters are formed;
a wiring layer where common wirings electrically connected to the plurality of heaters are formed; and
an anticavitation layer laminated in a first direction on the heater layer, the liquid ejection head print element board further comprising:
a first common wiring that is one of the common wirings and is for supplying voltage from an outside; and
a first plug that extends in an opposite direction of the first direction from the heater layer, fills an inside of a through hole directly connected to the heater with a conductive material, and supplies voltage to the heater, wherein
the first common wiring and the first plug are electrically connected to each other via wiring formed of a material identical to that of the anticavitation layer.

2. The liquid ejection head print element board according to claim 1, further comprising an insulation layer disposed between the heater layer and the anticavitation layer.

3. The liquid ejection head print element board according to claim 2, wherein the insulation layer has a film thickness that is less than a depth of the through hole.

4. The liquid ejection head print element board according to claim 1, wherein the first common wiring is located above the heater layer.

5. The liquid ejection head print element board according to claim 1, wherein the wiring formed of the material identical to that of the anticavitation layer is individually, electrically connected to each of the heaters.

6. The liquid ejection head print element board according to claim 1, wherein the wiring formed of the material identical to that of the anticavitation layer is formed by a process identical to that for the anticavitation layer.

7. The liquid ejection head print element board according to claim 1, wherein part of the wiring formed of the material identical to that of the anticavitation layer is formed of any one of Ta, Ti, TaN, and TiN.

8. The liquid ejection head print element board according to claim 2, wherein the wiring formed of the material identical to that of the anticavitation layer has a thickness greater than a film thickness of the anticavitation layer.

9. The liquid ejection head print element board according to claim 1, wherein the wiring formed of the material identical to that of the anticavitation layer includes a plurality of layers.

10. The liquid ejection head print element board according to claim 9, wherein the wiring formed of the material identical to that of the anticavitation layer includes: a first layer that is in contact with wiring on the heater layer side and is formed of any one of Ta, Ti, TaN, and TiN; and a second layer that is on an opposite side of the wiring on the heater layer side with respect to the first layer and is formed of at least Ir.

11. The liquid ejection head print element board according to claim 1, wherein an insulating material layer is further laminated in the first direction on the wiring formed of the material identical to that of the anticavitation layer.

12. The liquid ejection head print element board according to claim 11, wherein the insulating material layer is formed of any one of SiC, SiCN, SiOC, SiO, and SiOCN.

13. The liquid ejection head print element board according to claim 11, wherein a liquid ejection port is formed in the insulating material layer.

14. The liquid ejection head print element board according to claim 1, wherein the liquid ejection head print element board comprises a liquid chamber, and the wiring formed of the material identical to that of the anticavitation layer is disposed outside the liquid chamber.

15. A liquid ejection head comprising the liquid ejection head print element board according to claim 1, the liquid ejection head further comprising a plurality of ejection ports for ejecting liquid.

16. A printing apparatus comprising the liquid ejection head according to claim 15, wherein
the liquid is ink, the liquid ejection head is used as a print head ejecting the ink, and the printing apparatus prints on a print medium, and
the plurality of heaters are in contact with the ink, and the ink is ejected from the ejection ports by driving the plurality of heaters.
